(19) United States
(12) Patent Application Publication
(10) Pub. No.: US 2013/0144864 A1
(43) Pub. Date: Jun. 6, 2013

(54) Systems and Methods for Aggregation of Online Social Network Content

(71) Applicants: Bradford Lane Noble, Arlington, MA (US); Christopher Douglas Stolte, Chapel Hill, NC (US); Robert Talman Budd, Seattle, WA (US); Mads Anders Kvalsvik, Acton, MA (US); Stephen Green, Burlington, MA (US)

(72) Inventors: Bradford Lane Noble, Arlington, MA (US); Christopher Douglas Stolte, Chapel Hill, NC (US); Robert Talman Budd, Seattle, WA (US); Mads Anders Kvalsvik, Acton, MA (US); Stephen Green, Burlington, MA (US)

(73) Assignee: Boathouse Group, Inc.

(21) Appl. No.: 13/602,018

(22) Filed: Aug. 31, 2012

Related U.S. Application Data
(60) Provisional application No. 61/529,695, filed on Aug. 31, 2011.

(51) Int. Cl. G06F 17/30

(52) U.S. Cl. CPC G06F 17/30864
USPC 707/711

(57) ABSTRACT

A server contains an executable program and is in communication with an online social network. The server is accessed by a subscriber on a client system executing an application program interface to communicate with the server in which the server accesses indexes of data maintained on an online social network platform and retrieves the accessed data. The subscriber creates an account on the server. The executable program builds an index of relevant content for that subscriber to retrieve. The data is processed and aggregated on the server through a subscriber-specific relevancy engine on the server and the aggregated data is delivered to the subscriber on the client system in a searchable database. The subscriber may execute a search query on the client system in communication with the server and search query is processed returning relevant results to the user.

### CROSS-REFERENCE TO RELATED APPLICATIONS

This application claims priority to U.S. Provisional Application Ser. No. 61/529,695, filed on Aug. 31, 2011. Priority to this provisional application is expressly claimed, and the disclosure of the respective provisional application is hereby incorporated by reference in its entirety for all purposes.

### FIELD

The field of the invention relates generally to computer systems. In particular, the present method and system is directed to aggregating content from an online social network.

### BACKGROUND

Internet users are increasingly finding navigating information collections to be difficult because of the increasing size of such collections. Likewise, companies, individuals and other organizations wishing to be found by Internet users face growing challenges with maintaining their online visibility. Consequently, finding desired information in such a large collection, unless the identity, location, or characteristics of a specific document or search target are known, can create great difficulty for the Internet user.

Online social networks, such as Twitter®, have their own index of user data, along with an application programming interface, or API, that allows approved developers to access these indices. In one embodiment, PostPost, works by interfacing with these vast indexes of data maintained by platforms such as Twitter® and bring that data back to PostPost servers where they are indexed and searched.

Historically, traditional Internet search engines, like Google®, Yahoo®, and Bing®, search content from the Internet generally. This broad approach tends to capture too much information to be useful with respect to social search. Therefore, what is needed is a systems and methods for providing a more focused search and specifically searching data available in online social networks.

### SUMMARY

A computer-implemented method and system is disclosed comprising a client system in communication with a server. The server contains an executable program and is in communication with an online social network. The server is accessed by a subscriber on the client system executing an application program interface, or API, to communicate with the server in which the server accesses indexes of data maintained on an online social network platform and retrieves the accessed data. The data is processed and aggregated on the server through a subscriber-specific relevancy engine on the server and the aggregated data is delivered to the subscriber on the client system in a searchable database.

Online social networks, such as Twitter®, have their own index of user data, along with an API that allows approved developers to access these indices. In one embodiment, PostPost, works by interfacing with these vast indexes of data maintained by platforms, such as Twitter®, and bring that data back to PostPost servers where they are indexed and searched. Once granted rights to the index, the developer can write code, or “crawlers,” to make use of the data contained in the index. PostPost uses crawlers that allow the transfer of relevant data from Twitter's® index, for example, to PostPost's index (on PostPost servers), where the data can be searched by PostPost subscribers.

Another embodiment includes means for acquiring subjective user data, including data indicating at least one subjective user state associated with a user.

Another embodiment also includes means for presenting one or more results of the correlating data and displaying these results in order of relevancy to the user.

The above and other preferred features, including various novel details of implementation and combination of elements, will now be more particularly described with reference to the accompanying drawings and pointed out in the claims. It will be understood that the particular methods and circuits described herein are shown by way of illustration only and not as limitations. As will be understood by those skilled in the art, the principles and features described herein may be employed in various and numerous embodiments without departing from the scope of the claims.

### BRIEF DESCRIPTION OF THE DRAWINGS

The accompanying drawings, which are included as part of the present specification, illustrate a preferred embodiment, and, together with the general description given above and the detailed description of the preferred embodiment given below, serve to explain and teach the principles of the preferred embodiment.

FIG. 1 illustrates an exemplary flow diagram of a process of the present invention.

FIG. 2 illustrates an exemplary representation of an embodiment of the present invention.

FIG. 3 illustrates an exemplary embodiment of a home page of the present invention.

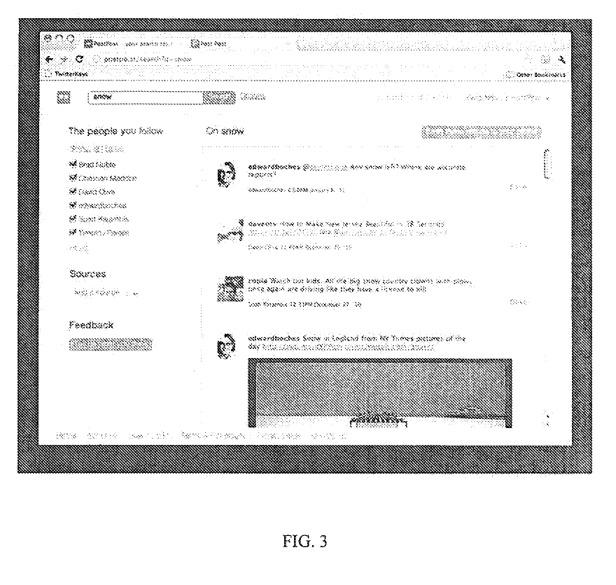

FIG. 4 illustrates an exemplary embodiment of a log-in page of the present invention.

FIG. 5 illustrates an exemplary embodiment of a search page of the present invention.

FIG. 6 illustrates an exemplary embodiment of a results page of the present invention.

FIG. 7 illustrates an exemplary representation of an embodiment of the present invention.

FIG. 8 illustrates a flow of the indexing of search results in one embodiment of the present invention.

FIG. 9 illustrates an exemplary representation of an embodiment of the present invention.

It should be noted that the figures are not necessarily drawn to scale and that elements of similar structures or functions are generally represented by like reference numerals for illustrative purposes throughout the figures. It also should be noted that the figures are only intended to facilitate the description of the various embodiments described herein. The figures do not describe every aspect of the teachings described herein and do not limit the scope of the claims.

In the following description, for purposes of explanation, specific nomenclature is set forth to provide a thorough understanding of the various inventive concepts disclosed herein. However, it will be apparent to one skilled in the art that these specific details are not required in order to practice the various inventive concepts disclosed herein.

### DETAILED DESCRIPTION

A computer-implemented method and system is disclosed comprising a client system in communication with a server. The server contains an executable program and is in communication with an online social network. The server is accessed by a subscriber on the client system executing an API to communicate with the server in which the server accesses indexes of data maintained on an online social network platform and retrieves the accessed data. The subscriber creates an account on the executable program on the server in communication with the online social network. The executable program on the server builds an index of relevant content for that subscriber to retrieve. The data is processed and aggregated on the server through a subscriber-specific relevancy engine on the server and the aggregated data is delivered to the subscriber on the client system in a searchable database. The subscriber may execute a search query on the client system in communication with the server and search query is processed returning relevant results to the user.

The relevant results may include Tweets from people who the executable program, Postpost's algorithm determines are relevant to that user and the names of the people (described in relation to facets below) who authored the Tweets (described in further detail below).

Also, a computer-implemented method and system, which monitors the number of times the user associates with or mentions (i.e., replies and/or retweets as is used in Twitter®) another person and processes the data as a factor in determining user relevancy is disclosed. In one embodiment, a predetermined number of people (e.g., the 100 or 150 people) that a user contacts or follows and that have the highest relevancy scores (i.e., mentions or retweets and replies added together, as in the case of Twitter®) are considered personally relevant for search result purposes.

Additionally disclosed is a computer-implemented method and system for prioritizing people a user follows who are not identified as personally relevant (e.g., not in the top 100 or 150 returned) but are the most mentioned people in the system index. The 50 people that a user follows with the most associations or mentions (Twitter® replies and retweets combined) by everyone in the PostPost index are also returned.

Also disclosed is a computer-implemented method and system where once a search has been returned, facets are displayed along the left side of the system display contain people associated with the user or that the user follows. When a user receives the results of the search displayed as facets, their interaction with those results increments the “personal relevancy” score for the author of that result among the people the user is associated with or follows. As consequence of the user selecting one of these facets (to drill down for results from that person), the system adds to that person's relevance (i.e., the facet drill-down is counted as if it were a tweet from that user in Twitter®, for example). By selecting facets, a user is indicating that that person/those people is/are relevant and those searches/drill-downs increase the relevance of that person/those people to the user, which impacts future results.

Accessing Postpost

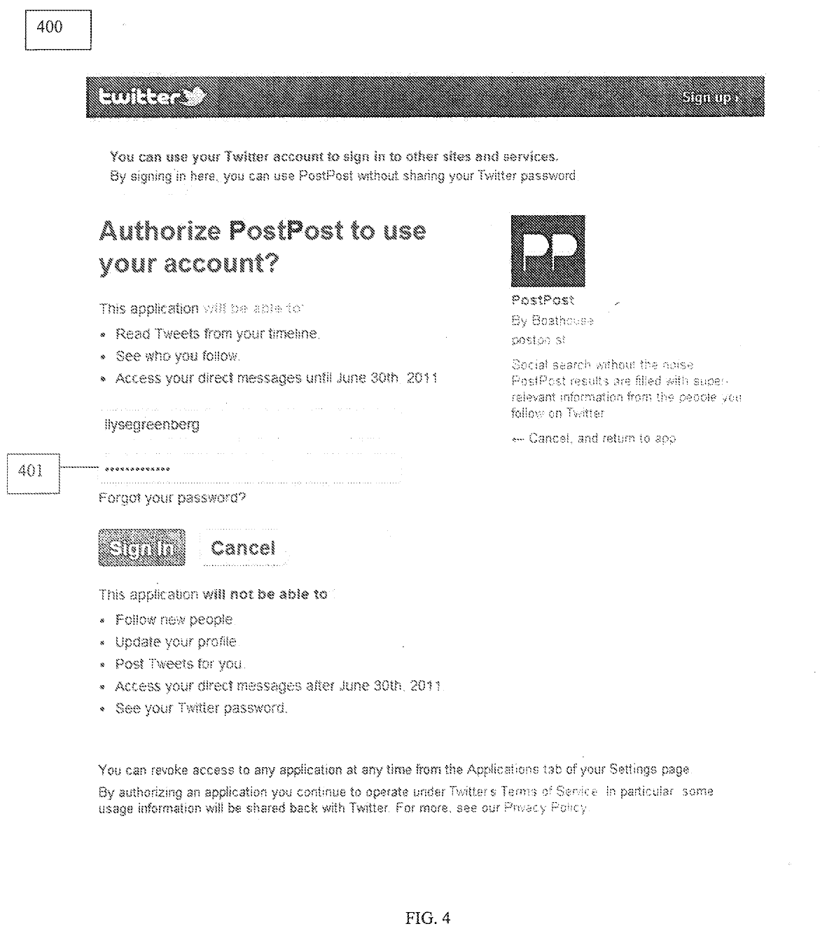

Referring to FIG. 4, in one embodiment, a user must have an existing account (or create a new one) in an online social networking site. Using Twitter® as an example, after clicking on “sign in with Twitter®,” users are sent to a Twitter® login page 400 authorizing PostPost to use the user's account information. On page 400, the user is given information on what PostPost will and will not do with its access to the user's Twitter® account. The user then logs in to the PostPost account 401 to conduct searches of data on the user's online social networking site, which is Twitter® in this example. Following a successful log-in, the user is sent back to www.postpost.com, where the search results are aggregated and displayed. This is a starting point where the user sees links, photos and video posts of the user and all of those whom the user follows on Twitter®, for example.

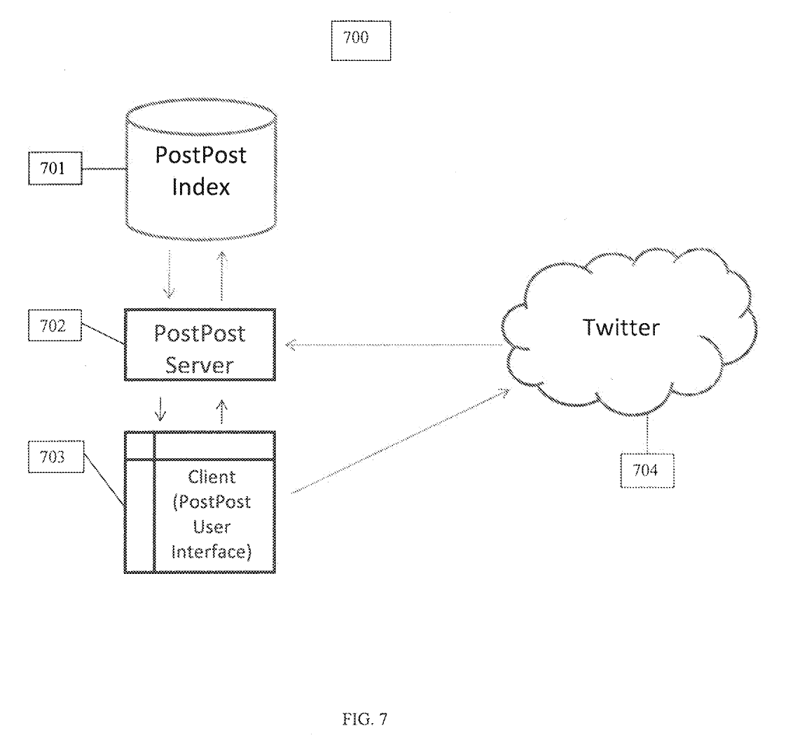

Referring also to FIG. 7, the user access process 700 for Twitter 704 from the client system 703 into the PostPost server 702 is then sent to the Twitter® 704 login for data from Twitter® 704 to be processed and indexed by PostPost 701.

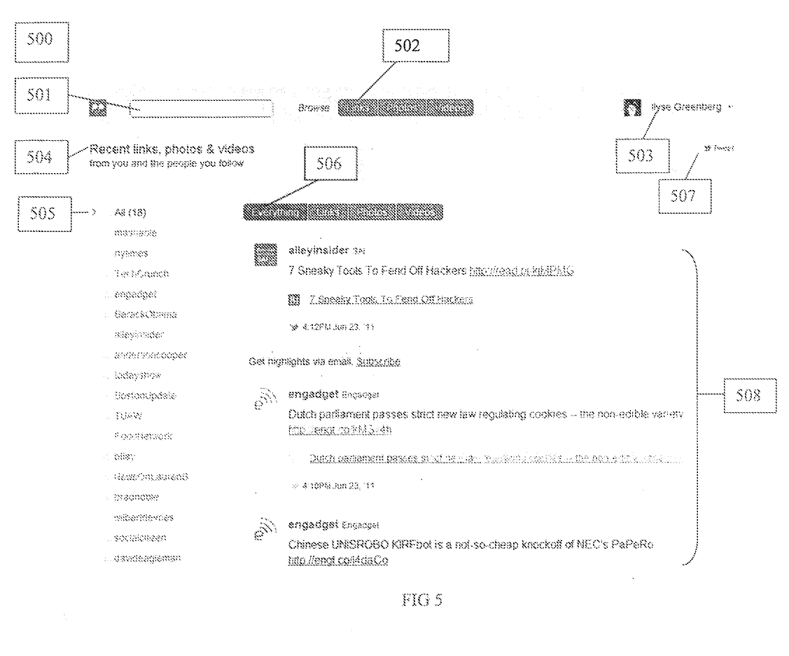

Referring to another exemplary embodiment shown in FIG. 5, upon entering the PostPost Web site 500 at www.postpost.com, users are prompted to sign in to Twitter® 503, for example, thereby making available the Twitter® history of the user and those whom he or she follows based on relevance. The user may then enter search terms to search data the user wishes to be displayed. An exemplary screen structure for the Twitter® example is as follows:

1) Search box 501 is a field for a keyword for searching the online social network database.

2) The user may Search by type of post 502 by selecting one of the available choices: link, photo, or video.

3) The user may access the user's login/settings 503 and make changes by selecting the link.

4) Description of current type of search results 504.

5) Results will be filtered by source 505 (i.e., the user and the people the user follows).

6) Results will be filtered by the type of post selected 506 (i.e, links, photos, videos).

7) Button enabling user to share link to search results with a tweet 507.

8) Timeline 508 listing the recent posts from the user and people the user follows.

The user may then enter search terms in field 501 to find specific content the user wishes to be displayed.

Postpost Results

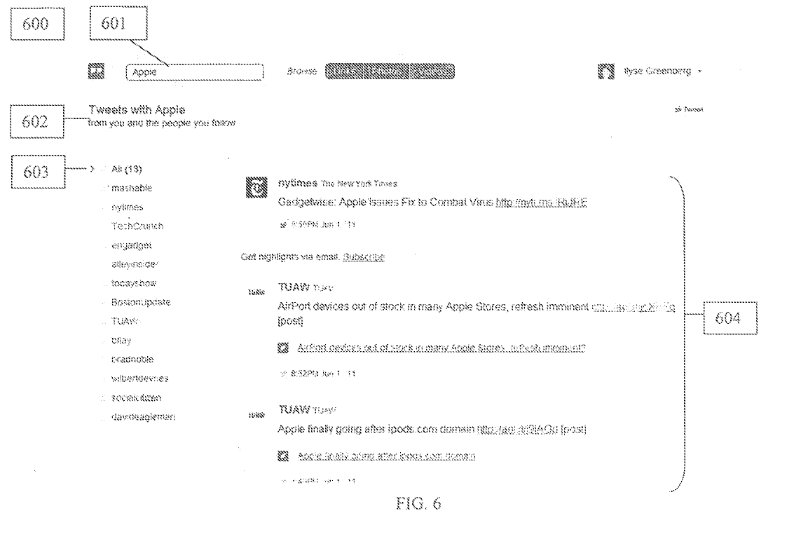

Referring now to FIG. 6 in another embodiment, the Twitter® screen 500 is re-displayed as screen 600. In this example, the user types in the word “Apple” as a search term in field 601 with the following results displayed:

1) The search box 601 is populated with the search term “Apple.”

2) Page ‘header’ 602 indicates that the search term has been used. In this example, with Twitter® chosen as the online social network, the header displays “Tweets with Apple.”

3) The results are displayed 604 in chronological order, with most relevant recent posts first.

4) The sources of the search results 603 are displayed and can be used as facets, which are organized by relevance, to further filter search results for greater relevancy.

Another embodiment is the method of prioritizing the results. The described system and method prioritizes and delivers results from within a user's history, profile, or timeline based on a relevance calculation. The relevance calculation is an algorithm that includes the user's history or timeline in the Twitter® example; people the user is associated with or mentioned; and people the user follows, plus other factors. The relevance calculation uses the number of mentions to indicate that one person is more relevant than another person and thus produces results more applicable to the user.

The relevance calculation determines who to index and search and orders their priority in the results. The user can then narrow results further by selecting a facet (i.e., of those a user follows) (see FIG. 6). Selecting a facet or clicking on a search result increases the relevance score of that person to the user (counted as if it were a tweet from that user in Twitter® for example). The facets selected by the user in future searches by the user provide results with increased relevancy to the user; thus, the system continuously improves the relevancy of the search results.

In another embodiment, in addition to “who,” underlying link content (dereferenced URLs and titles) are also indexed as well as tweets (tweets are about things even when those words don't exist with tweets—links may have more relevant information than tweets) or other types of communications. This additionally indexed information is also used to further narrow and tailor the results for the user.

In an additional embodiment, the results can also be filtered based on type and by source, such as links, photos and videos (see FIG. 5).

In yet another embodiment, the system allows users to share results with others and then follow those people from those search results to further discover valuable sources and content.

The results displayed in screen 600 provides the user with the ability to search an individual user's timeline in the example of Twitter®, rather than searching all of Twitter® as is the usual case. This saves the user time by producing the most relevant results for the user.

Relevancy

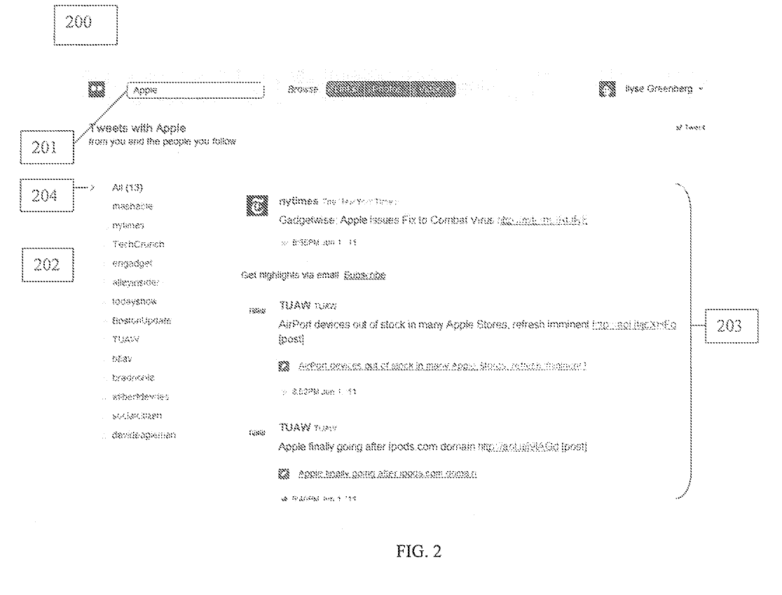

The system prioritizes the data that is most relevant to the users when returning results, whether a search term is used or not. In one embodiment, relevancy is defined by the present subject matter in the following ways. Referring to FIG. 2, an illustration of an exemplary embodiment of a search results window 200. The user may type in a search term in field 201 and the system generates results prioritized by the most relevant to the user, with relevancy determined by the following methods.

Personal Relevancy.

Refers to the relevancy to those people associated with the user or that a user follows. The amount of times the user mentions (reply and/or retweets, in the case of Twitter®) another person is seen as an indication that the user finds that person relevant. For example, the 100 or 150 people that the user follows who have the highest relevancy scores (mentions, retweets and replies, added together) are considered personally relevant for search result purposes.

Global Relevancy.

Refers to the relevancy to those people a user is associated with or follows who are not identified as personally relevant (i.e., not in the top 100 or 150 returned), The 50 people that a user follows with the most mentions (replies and retweets combined, as in Twitter®) by everyone in the PostPost index are also returned in the search results.

Combined Relevancy.

Refers to relevancy that takes into account both personal and global relevancy. When relevancy is not specifically identified as being either personal or global relevancy, combined relevancy is generally used.

Incrementing Personal Relevancy.

Once a search has been returned, facets 204 along the left side 202 of one embodiment contain people the user follows. Selecting one of the facets 204 (to drill down for results from that person) or by clicking on a search result adds to that person's relevance (i.e., in the case of Twitter®, the facet drill-down is counted as if it were a tweet from that person). By selecting facets 204, a user is indicating that that person/those people relevant and those searches/drill-downs increase the relevance of that person to the user, and that impacts future results.

The results 203 are displayed in chronological order, with most relevant recent posts first.

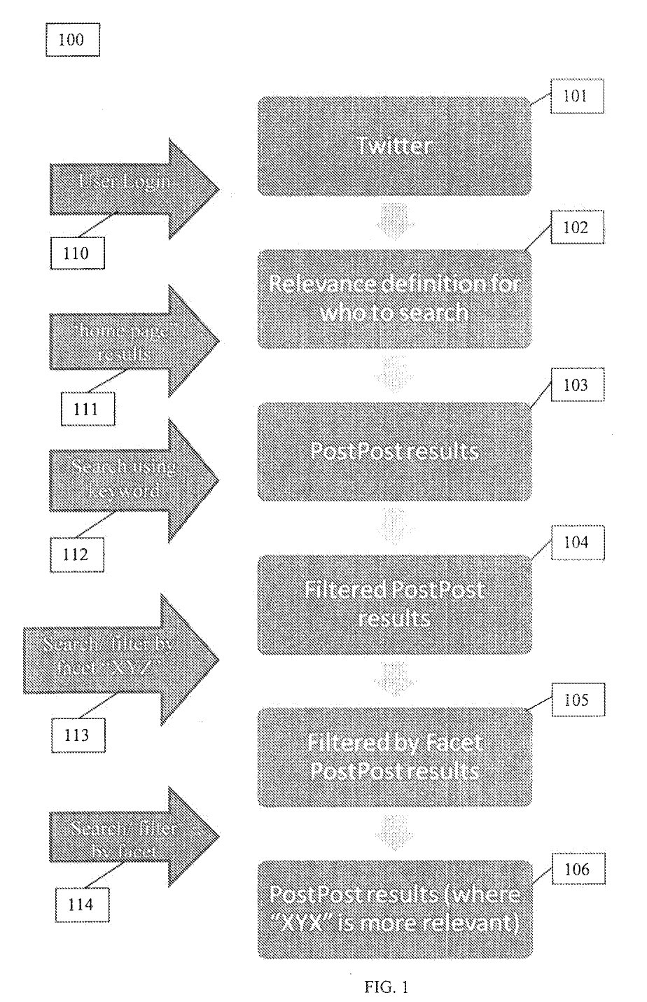

In a further description of an embodiment, referring to flowchart 100 in FIG. 1, upon entering the PostPost system Web site 101 at www.postpost.com, users are prompted to sign in 110 to Twitter or other available user networks, thereby making available the user's profile information, or in an exemplary embodiment of a Twitter® user, the Twitter® history of the user and those whom he or she follows. The search results are aggregated 102 and relevancy is determined by personal relevancy, global relevancy and relevancy from facet drill-down, each of which are detailed below. The results 111 are displayed 103 at the PostPost home page 112. The user can then conduct an additional search by keyword 113. In the Twitter® example, this is a starting point where the user sees link, photo and video posts of the user and all of those whom the user follows on Twitter®. PostPost “prioritizes” the data and returns results that are “most relevant” to the users when returning results 104, whether a search term is used or not. Most relevant is defined by PostPost as content from the “top 150” or “top 200” people a user follows who are most personally and globally relevant, where 100 or 150 are deemed personally relevant and 50 are deemed globally relevant.

Referring again to FIG. 1, the user may then click on a displayed facet XYZ 113 and the resulting facet drill-down treated as a mention, which is then processed 105 as relevancy for future search results. The PostPost system then displays a result 106, which is more relevant than previous results, and the user can input additional search terms 114. Results are impacted because XYZ is now more relevant due to drill-down of facet.

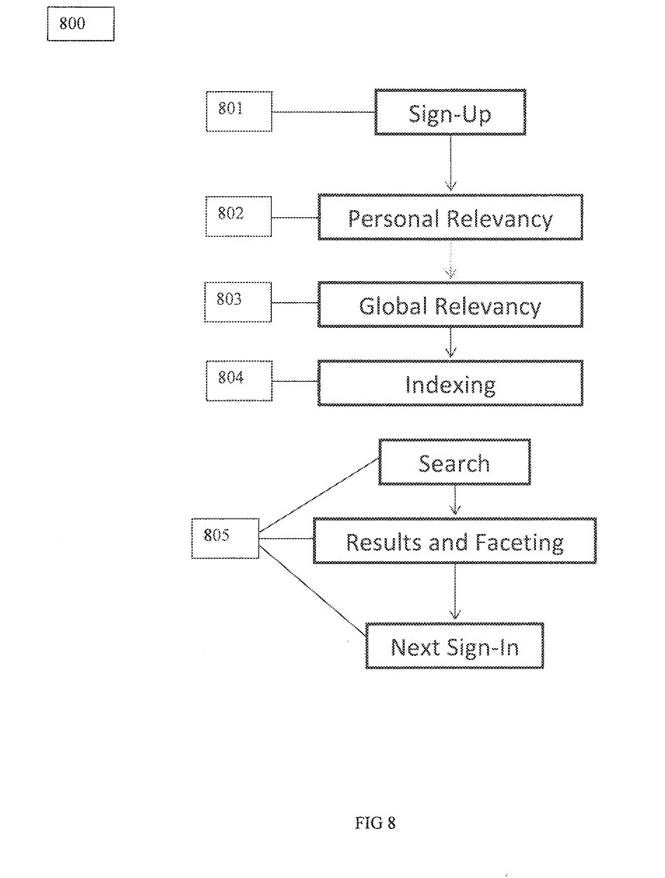

Referring to FIG. 8, a flow 800 of the indexing of search results is illustrated. Once the user signs in 801, the system processes the personal 802 and global relevancy 803 for indexing 804 to provide results and faceting 805 and then waits for a new search by the user.

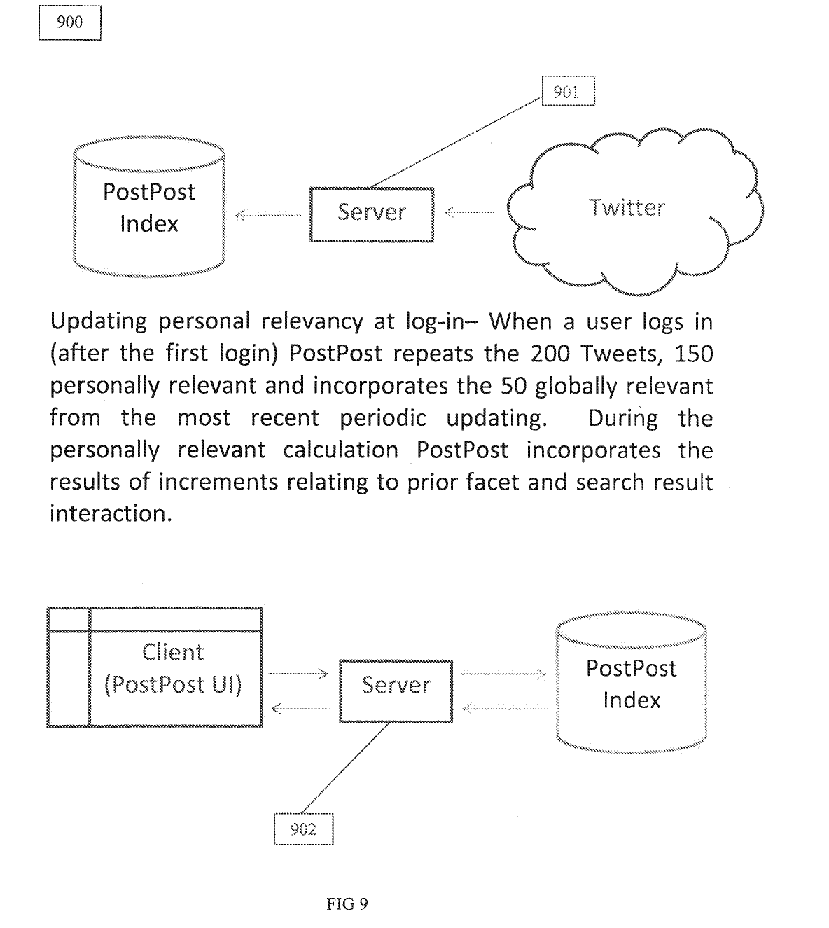

Another embodiment is illustrated in FIG. 9. The PostPost system 900 provides periodic updating. At general time intervals, the server updates existing accounts and searches for new content or Tweets, in the case of Twitter®, for mentions to update global relevancy scores 901. Additionally, for updating personal relevancy with Twitter® as an example, when a user logs in (after the first login), the PostPost system again retrieves the 200 Tweets with the highest relevancy score. The 150 with the highest personal relevancy score as determined by this embodiment and incorporates the 50 with the highest global relevancy score from the most recent periodic updating 902. During the personally relevancy calculation PostPost incorporates the results of incremented relevancy 902 relating to prior facet and search result interaction.

In yet another embodiment, content or tweets, in the case of Twitter®, without any links, photos or videos are not displayed. In this alternate embodiment, only the most meaningful content is thus displayed to the user.

Various changes, modifications, and variations, as well as other uses and applications of the subject invention, may become apparent to those skilled in the art after considering this specification together with the accompanying drawings and claims. All such changes, modifications, variations, and other uses and applications that do not depart from the spirit and scope of the invention are intended to be covered hereby and limited only by the following claims.

What is claimed is:

1. A computer-implemented method of aggregating data from a social networking platform comprising:
receiving user authentication for the social networking platform;
retrieving social media content maintained on the social networking platform based on a successful user authentication;
aggregating a searchable index, the searchable index comprising relevant content from among the social media content retrieved, each item of the social media content having an author, each of the authors having a relevancy score; and
providing a search engine for searching through the social media content and generating search results, wherein the search results comprise the relevant content, the relevancy score, and at least one facet, and wherein the search results are prioritizable according to the relevancy score and filterable using the at least one facet.

2. The computer-implemented method of claim 1, wherein the relevancy score comprises a personal relevancy score for each author.

3. The computer-implemented method of claim 2, wherein the personal relevancy score is determined by a number of mentions of the author from a selected user, wherein the author has a social network relationship with the selected user.

4. The computer-implemented method of claim 1, wherein the relevancy score comprises a global relevancy score for each author.

5. The computer-implemented method of claim 4, wherein the global relevancy score is determined by a number of mentions of the author from a plurality of users of the social networking platform, wherein the author has a social network relationship with a selected user from among the plurality of users of the social networking platform.

6. The computer-implemented method of claim 1, wherein the relevancy score comprises an incrementing personal relevancy score for each author.

7. The computer-implemented method of claim 6, wherein the incrementing personal relevancy score is determined by a number of times the relevant content is filtered by the at least one facet from the search results.

8. The computer-implemented method of claim 1, wherein the at least one facet comprises an author of the item.

9. The computer-implemented method of claim 1, wherein the at least one facet comprises a type of the item.

10. The computer-implemented method of claim 1, wherein the relevancy score comprises a combination of a personal relevancy score and a global relevancy score.

11. The computer-implemented method of claim 1, further comprising periodically retrieving the social media content for updating relevancy scores.

12. The computer-implemented method of claim 1, wherein said search results are prioritized in order of the relevant content having the highest relevancy score.

13. A system for aggregating data from a social networking platform comprising:
a server for communicating with a client system and the social networking platform, and for receiving user authentication for the social networking platform over a data network from the client system and retrieving social media content from the social networking platform;
a database in communication with the server for maintaining the social media content retrieved from the social networking platform based on a successful user authentication; and
a computer program product operatively coupled to the server, the computer program product having a computer-usable medium having a sequence of instructions which, when executed by a processor, causes said processor to execute a process that aggregates the social media content for providing a search engine, said process comprising:
aggregating a searchable index, the searchable index comprising relevant content from among the social media content of the database, each item of the social media content having an author, each of the authors having a relevancy score;
making the search engine accessible to the client system for searching through the social media content; and
generating search results comprising the relevant content, the relevancy score, and at least one facet, wherein the search results are prioritizable according to the relevancy score and filterable using the at least one facet.

14. The system of claim 13, wherein said relevancy score comprises a personal relevancy score for each author.

15. The system of claim 14, wherein the personal relevancy score is determined by a number of mentions of the author from a selected user of the client device, wherein the author has a social network relationship with the selected user.

16. The system of claim 13, wherein said relevancy score comprises a global relevancy score for each author.

17. The system of claim 16, wherein the global relevancy score is determined by a number of mentions of the author from a plurality of users of the social networking platform, wherein the author has a social network relationship with a selected user of the client device from among the plurality of users of the social networking platform.

18. The system of claim 13, wherein said relevancy score comprises an incrementing personal relevancy score for each author.

19. The system of claim 18, wherein the incrementing personal relevancy score determined by a number of times the relevant content is filtered by the at least one facet from the search results.

20. The system of claim 13, wherein the at least one facet is the author of the item.

21. The system of claim 13, wherein the at least one facet is a type of the item.

22. The system of claim 21, wherein the type of the item is at least one of a link, a photo, and a video.

23. The system of claim 13, wherein said relevancy score comprises a combination of a personal relevancy score and a global relevancy score.

24. The system of claim 13, wherein said process further comprises displaying a predetermined number of the search results to the client device.
